(19) United States
(12) Patent Application Publication
(10) Pub. No.: US 2004/0006739 A1
(43) Pub. Date: Jan. 8, 2004

(54) Method and system for converting legacy data

(76) Inventor: Craig Mulligan, Albany, NY (US)

Correspondence Address: Gibson, Dunn & Crutcher LLP, Suite 4100, 1801 California Street, Denver, CO, 80202, US

(21) Appl. No.: 10/360,835

(22) Filed: Feb. 7, 2003

Related U.S. Application Data
(60) Provisional application No. 60/355,226, filed on Feb. 7, 2002.

(51) Int. Cl. G06F 15/00

(52) U.S. Cl. 715/513

(57) ABSTRACT

A method is provided in which, responsive to a transaction request from a client machine, the transaction request is searched for any key words. If there are any key words present, the associated data and one or more driver parameters are retrieved from the database. The driver parameters are then placed into a data array for processing. Thereafter, control is passed to an XML object processor. While processing the parameter cards, which are the XML object structures, if an embedded tag is encountered, control is passed to a subsequent copy of the program, which then processes the embedded object. The parameter cards for each object may be used to invoke further database calls to retrieve any additional data required to fulfill the object. As each process completes, the “prior” application is run until the object and all associated data have been retrieved and assembled. Once all processes are complete, the processed data is transmitted to the client machine for display.

Method and System for converting legacy data into one or more useable forms including, without limitation, extensible markup language (XML). This application claims priority from provisional application serial No. 60/355,224 filed on Feb. 7, 2002.

### BACKGROUND OF THE INVENTION

1. Field of the Invention

The invention relates to a process for converting data and specifically to the process of converting legacy data into a format that can be viewed via the Internet.

2. Description of the Related Art

Currently,-it is not uncommon for insurance, aerospace, retail, banking manufacturing, communications, health care, and financial companies to provide an interface, via the Internet, for providing access to a user's data. The problems associated with enabling this access include: (a) much of the data on a user is stored in legacy systems; (b) legacy systems often require very specific and proprietary processing instructions; and (c) once the data is retrieved, the data often needs to be placed in a useable format.

Many information systems being used today in certain established industries, insurance, aerospace, retail, banking manufacturing, communications, health care, and financial companies, use a system called the Information Management System or IMS (some estimates place ISM penetration at close to 90% in these critical industries). IMS in comprised of two primary components: a transaction management system and a hierarchical database management system. The IMS transaction manager includes a facility called an open transaction manager access facility or OTMS. OTMA provides an easier way of enabling users that connect to a system using the TCP/IP protocol to make information requests to IMS. OTMA further includes a cross-system coupling facility (XCF) that facilitates communications between OTMA and OTMA clients.

The process of delivering data to web applications in the prior art was to first invoke a transaction (submit a transaction request) through a message queue (MQ) series, The requested transaction is then passed to OTMA, which in turn passes it to the IMS for processing by applications being managed by IMS. Once the transaction is complete, a reply is passed back through OTMA and eventually back to MQ. MQ then strips off any data that was included in the request (the MFS overhead) and the data is delivered to the middleware layer. Thereafter, either the middleware layer (or the underlying web application) receives the data and places it into a useable format.

As can be appreciated, this process involves several steps resulting in both a longer lag time prior to delivery to the web application and requires multiple transaction requests that creates significant overhead (such as MFS overhead) on the overall system. What is needed, then, is a system in which a transaction would be invoked using the same software tools in a single request and which could deliver the data into a useable format without requiring the same MFS overhead.

### BRIEF SUMMARY OF THE INVENTION

The following invention addresses the above-mentioned needs in the art by providing a method for submitting and processing data requests without requiring any extra overhead wherein the data requested by the transaction is delivered in an XML format. The method begins when the IMS control region evokes one of the legacy transactions, passing the I/O area containing the message to the transaction. The control region is the execution environment for the IMS system software, the control blocks and storage pools required for managing communication access and application program scheduling. In the preferred embodiment, the transaction passes the I/O area to a program, such as E900010. E900010 scans the I/O area and breaks out each of the key words passed in the I/O area. If no key words have been passed or identified by E900010, the transaction ends and a code indicating the no key words were present is returned. If key words were passed, control is temporarily passed to the database portion of IMS server to determine if the requested data is housed within the database. If there is no data for the request, a code indicating this fact is returned. If data is detected, the transaction continues by retrieving the driver parameters. In the preferred embodiment, the driver parameters are retrieved from the database using the E9000DBP module provided with IMS. These parameters are then placed into a data array for processing.

Once the data keys have been set and the driver parameters stored, control is passed to an XML object processor. Using pointers to the data array, the system begins processing the “object.” While processing the parameter cards, which are the XML object structure, if an embedded tag is encountered, the program passes control to a subsequent copy of itself, which then processes the embedded object. The parameter cards for each object may be used to invoke further database calls to retrieve any additional data required to fulfill the object. As each process completes, the “prior” application is run until the object and all associated data have been retrieved and assembled.

This recursive process (or emulated recursive process) is normally not permitted by Cobol but the process above avoids this restriction. Additional functions may also be used, For example, E900UCNV may be driven by the parameter cards to clean any character strings in the data that resides on the database on internal processing area. E9000LMS may be used to prefix and postfix each piece of data with the tag housed within the parameter cards. The data is subsequently processed into the I/O area, which is then returned to the requestor. Finally, E9DSPLY may be used for debugging purposes.

### BRIEF DESCRIPTION OF THE FIGURES

FIG. 1 is a block diagram illustrating a standard IMS system including OTMA and IMS connections.

FIG. 2 shows a schematic/block diagram of a computer system.

FIG. 3 is a block diagram illustrating the flow of data in one embodiment of a computer system logically connected to the system and method of the present invention.

FIG. 4 is a flowchart illustrating how a transaction request is submitted to the IMS server.

FIG. 5 is a flowchart illustrating the improved transaction processing and data conversion process of the present invention.

### DETAILED DESCRIPTION OF THE INVENTION

Reference will now be made in detail to the construction and operation of preferred implementations of the present invention illustrated in the accompanying drawings. In those drawings like elements and operations are designated with the same reference numbers when possible. The following description of the preferred implementations of the present invention are only exemplary of the invention. The present invention is not limited to these implementations, but may be realized by other implementations.

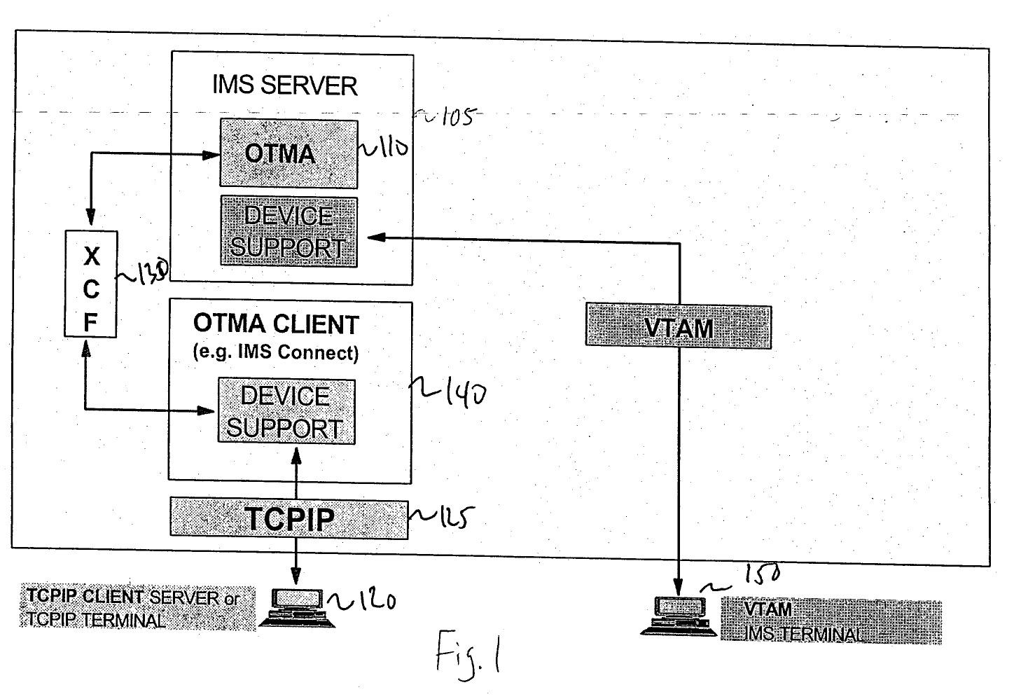

Many information systems being used today in certain established industries, such as financial, banking and insurance providers, use a system called the Information Management System or IMS. Referring now to FIG. 1, a block diagram illustrating a standard IMS system 100 that may be used in accordance with the present invention is shown. IMS 100 in comprised of two primary components: a transaction management system and a hierarchical database management system (not shown). The IMS system 105 includes a facility called an open transaction manager access facility or OTMA 110. OTMA 110 provides an easier way of enabling computer system 120 using a transmission control protocol/internet protocol (TCP/IP) connection 125 to make information requests to IMS server 105. OTMA 110 further communicates with a cross-system coupling facility (XCF) 130 that facilitates communications between OTMA 110 and OTMA clients 140. Alternatively, an IMS terminal 150 may also be used to communicate and otherwise submit requests to the IMS Server 105.

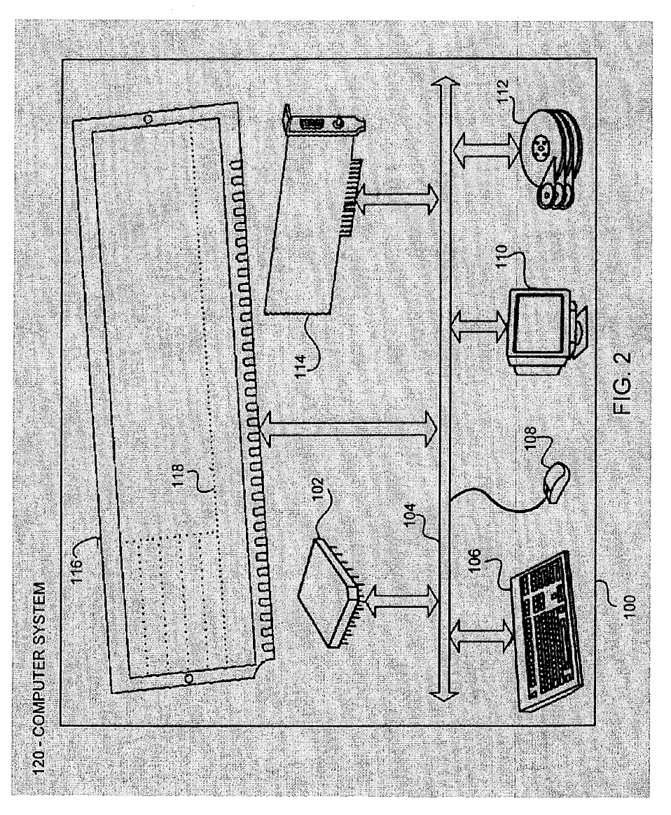

FIG. 2 shows a basic computer system 120. The computer system 120 contains a Processing Element 202. The Processing Element 202 communicates to other elements of the Computer System 200 over a System Bus 204. A Keyboard 206 allows a user to input information into Computer System 200, and a Graphics Display 210 allows Computer System 200 to output information to the user. Graphical Input Device 208, which may be a mouse, joy stick, or other type of pointing device, is also used to input information. A Storage Device 212 is used to store data and programs within Computer System 200. A Memory 216, also connected to System Bus 204, contains an Operating System 218, and relevant Software 220. A Communications Interface 214 is also connected to System Bus 204. Communications Interface 214 may have one or more serial ports, parallel ports, infrared ports, and the like. Connectable through Communications Interface 214 may be an external printer or scanner, as well as access to a computer network (LAN or WAN), to the Internet, or to any other appropriate communication channel.

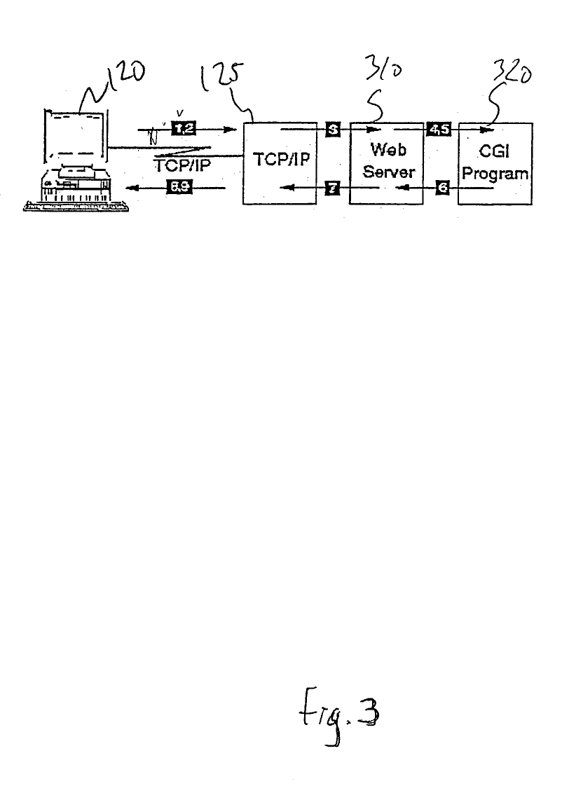

Referring now to FIG. 3, a sample embodiment of a computer system 120 running one or more web based applications and interacting with the IMS server is shown. In this example, the web-based applications include a web browser. In the preferred embodiment, the web browser supports the extensible markup language or XML Using this browser, a request is submitted for data and that request is submitted via TCP/IP 125 to a web server 310. The web server 310 may further include various CGI programs and/or scripts 320 that receive messages from the web browser and processes the transaction. As explained above, in the prior art, the process of delivering data to web applications that are running on a computer system 120 begins by invoking a transaction through a message queue (MQ) series (not shown). The requested transaction is then passed to OTMA client 140 and OTMA 110, which in turn passes it to the IMS 105 for processing. Once the transaction is complete, a reply is passed back through OTMA 110 and eventually back to MQ. MQ then strips off any data that was included in the request (the MFS overhead) and the data is delivered the CGI program 320. The CGI program 320 then delivers it back to the web server 305 that transmits the final result via TCP/IP 125 for display on the computer system 120.

For example, let us assume that the requesting agent enters information into the computer system 120 and submits a request to update their address via a web server 310. In the medical-insurance industry, the requesting agent may be a physician's office, medical center, hospital etc and the relevant software 220 in the computer system 120 might be the Physician Office and Management System. In a preferred embodiment of the invention, the Web server 310 reviews the information entered by the requesting agent in real time for embedded viruses and errors. Also, web server 310 may also verify the authority of the requesting agent to access the requested transaction. In a preferred embodiment of the invention, the formats and field sizes of all data elements of the information entered by the requesting agent are analyzed by the web server 310 and mis-keyed or erroneous data is brought to the attention of the requesting agent. In this way, any submitted request with incompatible data is halted and a notice highlighting the incompatible data is returned to the requesting agent. In the preferred embodiment of the invention, the web server 310, in conjunction with one or more CGI programs 320, creates a string of the data submitted by the requesting agent and this string is converted through a real-time transaction into the appropriate entry format for the OTMA client 140.

Thereafter, a transaction record is created by storing one or more attributes relating to the requesting agent's transaction into a single entry having a locally unique identifier. The identifier could be a database entry address, a pointer to memory location, an offset value, or other methods that can be used to establish a locally unique identifier for the stored data. Not all attributes need necessarily be stored, only attributes relating to the requested host or process. In the preferred embodiment of the invention, the attribute or attributes relating to the requested host process are stored in a database that is associated with or under the control of the IMS server 105 and given a unique identification. For example, the attributes could be assigned a unique ID by storing separate instances within the same database. In the preferred embodiment of the invention, an identifier associated with the requesting agent or the person for whom the request is made; i.e. home address or telephone number, is stored in the Database.

In the middleware, an initial tier of the IMS server (or associated programs or routines) prepares and formats the requesting agent's submitted transaction for transmission to a host (not shown). While this invention will be described with reference to managing an assortment of transactions, the invention could also be applied in such a way that only related transactions are managed by the same transaction manager. By way of example, the initial tier of the system may use Enterprise Java Beans (“EJB”) to access the database associated with a host. (Java Beans is a trademark of Sun Microsystems, In.). As persons familiar with the art are aware, a Java Bean can be used to access data or applications that create data, from a legacy host or database.

The Transaction Manager of the IMS server 105 transmits the formatted transactions to a host. In the preferred embodiment, a host is a unit that includes at least one processor and one or more instructions associated with a process performed by the host. For example, a host may be an “update host” that updates entries to a particular database. While the word host implies singularity, the “host” unit may comprise one or more actual processing units that may be physically separated or otherwise distributed on a given network. Finally, the designation of a processing unit as a “host” in one transaction does not restrict the host from serving as an initiating agent in the same or related transactions. For example, a given host may submit requests to one or more host “subprocessing” machines. As a result, a single requested transaction could result in transaction entries for different layers of processing. Alternatively, there could be only a single transaction record that includes each host that will be used (whether directly or as a “subprocess” host) to complete the requested transaction. When the host is available, it receives and can commence processing the transaction request sent by the requesting agent via the middleware bridge (if applicable).

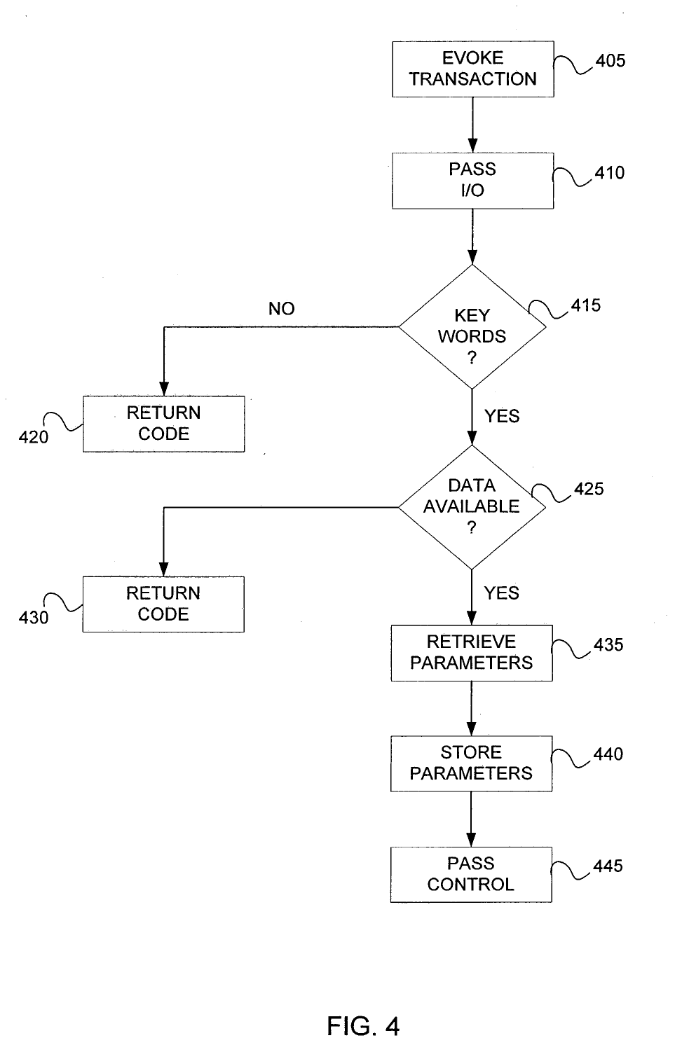

Referring now to FIG. 4, a flow chart illustrating the method of the present invention is shown. The method of the present invention begins when the IMS server 120 receives the transaction request and the control region of the IMS Server 120 evokes 405 one of the legacy transactions, passing the I/O area containing the message to the transaction. As explained above, the control region is the execution environment for the IMS system software, the control blocks and storage pools required for managing communication access and application program scheduling.

In the preferred embodiment, the transaction passes 410 the I/O area to a program, such as E900010. In the preferred embodiment, E900010 breaks out or otherwise identifies 415 each of the key words passed in the I/O area. Again, the specific manner in which this is performed is not relevant to the present invention provided that the program being used is capable of identifying one or more key words in the transaction request. If no key words have been passed or identified by E900010, the transaction ends and returns 420 a code indicating the no key words were present. If key words were passed, control is temporarily passed to the database portion of IMS to determine 425 if the requested data is housed within the database. If there is no data for the request, the system returns 430 a code indicating this fact. If data is detected, the transaction continues by retrieving 435 the driver parameters. In the preferred embodiment, the driver parameters are retrieved from the database using the E9000DBP module provided with IMS. These parameters are then stored 440 in a data array for processing. Once the data keys have been set and the driver parameters stored, control is passed 445 to an XML object processor.

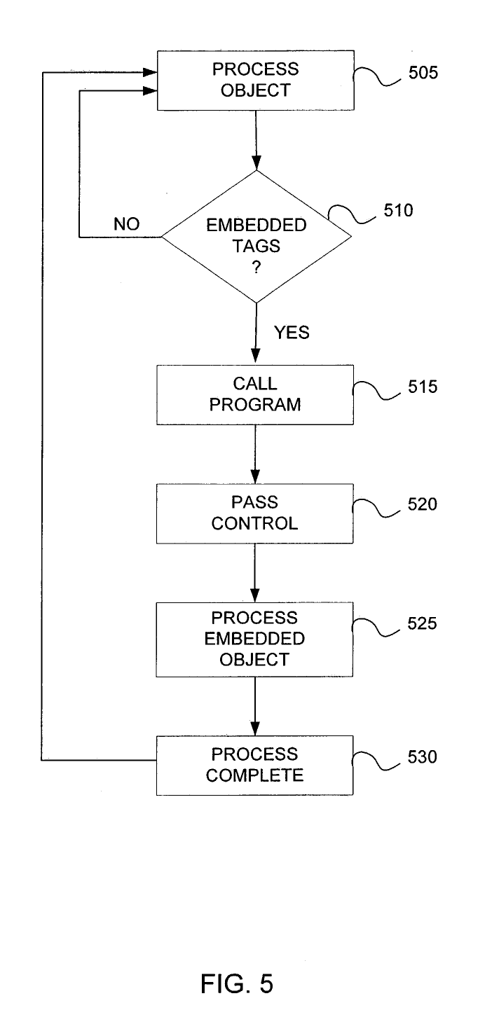

Referring now to FIG. 5, a flow chart illustrating the XML processing of the present invention is shown. Using pointers to the data array, the system begins processing 505 the “object” including both the data keys and parameter cards. While processing 505 the parameter cards, which are the XML object structures, the program determines if an embedded tag is present 510. If not, the program continues to process 505 the object accordingly. If an embedded tag is encountered, the program creates or calls another instance of the program 515 and passes control 520 to the subsequent copy of itself. This “copy” or additional instance then processes the embedded object. The parameter cards for each object may be used to invoke further database calls to retrieve any additional data required to fulfill the object. As each process completes 530, the “prior” application is run until the object and all associated data have been retrieved and assembled. While the flowchart only illustrates the processing of a single embedded tag, it is quite possible for the embedded tag to itself included embedded tags. In such a case, another instance of the program would be created to process this “second level” embedded tag. Again, this process can continue to call additional copies of the program until the last of the embedded links have been resolved.

This recursive process (or emulated recursive process) is normally not permitted by Cobol (the base language used in IMS) but the process above avoids this restriction. Additional functions may also be used, For example, a program or call, such as a call to E900UCNV, may be driven by the parameter cards to clean any character strings in the data that resides on the database on internal processing area. A program or call, such as E9000LMS, may be used to prefix and postfix each piece of data with the tag housed within the parameter cards. Finally, a program or call, such as E9DSPLY, may be used for debugging purposes. Once the data has been fully processed it is returned to the I/O area, which is then returned to the requestor.

The present invention provides a number of important benefits. First, flexibility is achieved by allowing the addition of parameter cards. If a parameter card is added, additional data is sent to the web server 310 within the XML object with little to no additional coding. If the data has already been retrieved, all of the data is available to be sent. Second, this approach that the programs are reusable. This is because, in the preferred embodiment, most of the work modules may be called dynamically. This allows the same code to be used by multiple transactions. This also allows for a uniform flow through each of the transactions resulting in easier production maintenance.

Second, the speed of processing is increased because multiple steps are eliminated. The first step that is eliminated is the work done via MQ series calls. In the simplest case, the work of stripping off the additional data sent with traditional transactions tacked on by MFS is eliminated, for example. Additionally, since the transaction was built from scratch meaning that MFS was not used, the transaction is allowed to directly respond back to the requester with an XML object.

Finally, traditional transactions are built to serve inquiry processing meaning that the inquiry often requires that multiple transactions be invoked to satisfy a submitted request. By having a stand-alone web transaction, the system only invokes one transaction instead of 15 to 25 transactions. This would often have be the case when using the E9SVLD of the IMS server 105 for example. The step of reformatting the responses from the multiple transactions has been eliminated because the response is in an XML format, which can be used immediately by the web application.

The foregoing description of the preferred embodiments of the invention has been presented for the purposes of illustration and description. For example, although described with respect to a particular set of functions provided by IMS, any number of different functions that provide similar capabilities could be used to implement this invention. Additionally, the claimed system and method should not be limited to the particular system and met work configurations disclosed. For these reasons, this description is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for retrieving and converting data, wherein such data is managed by an IMS server, and processed according to the following steps:
identifying one or more key words in a transaction request;
responsive to the identification of a key word, retrieving the data and one or more parameters cards (collectively, the “XML object”) from one or more databases being managed by the IMS server;
processing the XML object by tagging he data according to the parameter card(s) retrieved; and
responsive to the presence of an embedded tag in the XML object:
calling one or more duplicate program(s);
passing the embedded object referenced by the embedded tag for processing by the duplicate program; and
processing the embedded object.

2. The method of claim 1, wherein the step of processing the embedded object is accomplished by performing the steps performed in claim 1.

3. The method of claim 1, wherein the steps of identifying, retrieving and processing are performed by an original program.

4. The method of claim 3, wherein the step of calling one or more duplicate program(s) includes the step of creating an additional instance of the original program.

5. The method of claim 4, further comprising the step of passing the results of the duplicate programs back to the original program.
